(19) United States
(12) Patent Application Publication
(10) Pub. No.: US 2009/0258641 A1
(43) Pub. Date: Oct. 15, 2009

(54) MULTI-INTERFACE PARSABLE MOBILE DEVICES (PMD) FOR ENERGY CONSERVATION AND SERVICES ENHANCEMENT

(75) Inventors: Raziq Yaqub, Stewartsville, NJ (US); Kazuo Nogami, Sagamihara-shi (JP)

Correspondence Address: WP&D unit of Westerman Hattori Daniels & Adrian;LLP, 1250 Connecticut Ave., Suite 700, Washington, DC, 20036, US

(73) Assignees: TOSHIBA AMERICA RESEARCH, INC., Piscataway, NJ (US); KABUSHIKI KAISHA TOSHIBA, Tokyo (JP)

(21) Appl. No.: 12/329,573

(22) Filed: Dec. 6, 2008

Related U.S. Application Data
(60) Provisional application No. 61/044,495, filed on Apr. 13, 2008.

(51) Int. Cl. H04W 4/00; H04M 1/00

(52) U.S. Cl. 455/426.1; 455/574

(57) ABSTRACT

A split-able mobile device includes a parsed mobile device (PMD) and a pre-associated peer partner (PPP) that enables communication with networks when the PMD is in the vicinity of the PPP. The PMD locates the PPP and enters into peer mode. In peer mode, the PMD shares a function or operation with the PPP to reduce power costs or to alleviate overhead constraints. The PPP accesses a separate power source than the PMD and can provide greater service to a user without compromising performance of the PMD. If the PPP cannot be located, then the PMD enters a solo mode.

### FIELD OF THE INVENTION

The present invention relates to improving services and power consumption of a mobile device. More particularly, the present invention relates to a split-able mobile device, or plurality of devices seen by the network as a single device, having different modes of power consumption that conserve battery life and increase services and functionality within the mobile device or extend services to secondary device(s) with a more desirable form factor, thus encouraging convergence.

### DISCUSSION OF THE RELATED ART

Low power, energy efficiency and convergence of services are key requirements of current and future mobile terminal design, especially when the lifetime on a single battery charge is an important feature. Limited battery life impacts a mobile device due to the nature of being portable and small, which prevents the placement of a large, high capacity battery or power supply on the device. Further, consumers expect that each iteration or upgrade of a device to include the latest network interfaces and services. These newer features and services require more energy, or more desirable form factor, thereby forcing developers to continuously deal with increasing energy requirements.

Attempts to address these problems usually seek to develop higher capacity batteries, but battery life only increases at a rate of 5-6% yearly. This rate is not adequate enough to keep pace with technological advances and the burdens added by demands placed on the mobile devices. Thus, usable battery lifetimes keep getting shorter because battery technology is unable to offset the increasing energy requirements.

Various techniques are used to increase battery life. These techniques may be categorized as techniques pertaining to the hardware enhancements, techniques pertaining to the software enhancements, such as codes, protocols and algorithms, techniques pertaining to system architecture, and techniques pertaining to screen display. These techniques are discussed in greater detail below.

Among known hardware based techniques for power optimization and management, dynamic voltage scaling involves resource slowdown or processor slowdown through a reduction in the supplied voltage to the mobile device. Dynamic voltage scaling may be implemented in laptops, personal digital assistants (PDAs) and cell phones. Dynamic voltage scaling, however, trades off performance for energy savings by reducing processor speed and/or the clock speed of a processor when a mobile system is idle or computing a low-priority task.

Dynamic voltage scaling also produces a negative effect on memory and network interfaces. Some smaller components within the processor do not scale well with dynamic voltage scaling. While the processor may use less energy, these smaller components, such as phase locked loop (PLL) circuitry, will continue to use the same amount of energy as if the processor was operating at full capacity. Moreover, additional energy costs are incurred by waking up and shutting down the processor. For example, when a processor is put into the lowest energy-consuming mode, or essentially shutdown, the processor may lose all of its register and cache data. Thus, on a shutdown, all of the information residing in the registers is stored into memory, thereby requiring an energy consuming write operation.

When the processor later awakens, the stored information will be read from memory, and the registers are filled once again with the appropriate values saved prior to the shut down operation. Further, the cache may be empty, initially leading to cold hits when the cache is first accessed, which delays the delivery of data. Thus, resource shutdown may not be the appropriate solution for all mobile devices.

Software-based approaches include compilation and optimization of communication codes for battery longevity. Optimization may enable the codes to run more efficiently and decrease the memory requirements of the codes. Optimization also may reduce the amount of power needed to run the application. The energy needs are reduced primarily due to the performance gains, which allow the processor and the device to execute the codes quicker and with reduced resources. Optimization of code, however, results in additional hours preparing and modifying the codes to be more efficient. Further, the optimized code may not be totally compatible with the mobile device or other network elements.

Code compression is another alternative way to achieve performance gains, but code compression, however, comes with its own problems. For example, code abstraction may introduce significant run-time overhead if it is blindly implemented. Further, manpower and resources must be used to develop the code compression algorithms and schemes.

Communication protocols also may impact on the overall power consumption and energy efficiency of wireless communication by mobile devices. Power-saving protocols, as applied in known IEEE 802.11 wireless local area network (WLAN) cards, may turn off the network interface according to a local decision based on the traffic need. If a node has to transmit or receive data, the node stays awake. Otherwise, the node can enter sleep mode to save energy. A node checks periodically whether packets have to be sent or received. This “check” requires a centralized or more complex distributed synchronization algorithm. In a centrally scheduled communication system, such as a HiperLAN/2, the scheduling periods can be too short to justify aggressive turning off because of the additional overhead in time and energy to turn a transmitter ON again. For example, the scheduling periods for HiperLAN/2 may only be about two milliseconds.

Algorithms also are used to achieve power optimization. For example, one such algorithm dictates that the transmitter cease transmission to save power when the chances of successful reception are low, such as when a transmitter does not receive acknowledgements after packet transmissions. Another option is to retransmit at increased power. This option may reduce the possibility of transmission errors but increases the signal-to-interference ratio (SIR) of the network. The determination of when and at what power level that a mobile device should attempt retransmission is an important consideration for the optimum use of power at the data link layer.

For a system level perspective, several factors impact the battery life of a mobile device. For example, the noise temperature in code division multiple access (CDMA) systems may impact battery life. If the noise temperature is reduced by 1 dB, the CDMA system can provide a gain of 20% of the CDMA mobile device battery life. There would, however, be a 10-15% decrease in the coverage area of the CDMA cell sites. Further, the service providers may have to add 12-17% more cell sites to maintain present coverage. Such an increase would impose tremendous costs. Further, in certain locations, the addition of more cell sites to make up for the substantial loss in coverage may not be practical due to local zoning issues and other difficulties with available land. Moreover, increasing the infrastructure density with more base stations will cause an increase in complexity in the RRM algorithms.

The use of a lower density modulation scheme if the channel quality decreases and vice versa, or rate adaptation, is another technique to optimize throughput and energy efficiency for varying channel conditions. A drawback of rate adaptation is that it requires more linear power amplifiers and linearity lowers the battery life in a mobile device. Rate adaptation also may be used to avoid energy-hungry radio processing operations. For example, in HiperLAN 1, packet headers are sent at 1 Mbit/second while the payload information is sent at a rate of 23 Mbits/second. Systems under IEEE 802.11 may follow a similar paradigm. A higher data rate consumes considerably more energy. Thus, a node can decide on the basis of the control information within the packet header sent at 1 Mbit/second whether the payload should actually be received.

Power saving by intermittently turning off transmission and reception has been investigated for wideband CDMA (WCDMA). In voice activity detection (VAD), the transmitter is turned off when the conversation pauses to conserve battery life. With no signal on a particular voice connection, the channel uses far less power. Further, in the gated transmission mode, a subset of time slots is used for data transmission and reception. The performance evaluation of gated transmission, a reduction in uplink interference of up to about 2.5 dB might be achievable.

Unused network interfaces may be turned off in multi-mode devices to save energy. A problem, however, of shutting down interfaces is the uncertainty when the network interface needs to be turned on again. Further, the act of powering up an interface incurs additional power consumption in time and energy, and may be inconvenient. Turning various interfaces on and off also poses problems for mobile device operation.

Thus, several techniques may be used to reduce power consumption in mobile devices. These techniques, however, suffer from shortcomings or a sacrifice in service, as discussed above. Moreover, implementation of the techniques may result in costly or inconvenient upgrades or new space requirements within the mobile device.

### SUMMARY OF THE INVENTION

The disclosed embodiments of the present invention relate to an adaptably split-able mobile device (SMD) that automatically adapts to two different modes to conserve power consumption. The two modes may be referred to as “peer mode” operation (PM) and “solo mode” operation (SM). A switch to an appropriate mode will be automatic at the mobile device, and may be triggered by the presence or absence of an authorized pre-associated peer partner (PPP). The PMD and the PPP form a split-able mobile device (SMD). The disclosed embodiments also may be regarded as a self-organizing peer-to-peer system to offer modern communication services by reducing power consumption using existing resources in a novel and unique manner.

Peer mode corresponds to a situation where the PMD can find and communicate with the PPP. The PPP may be an on-board server (OBS) installed in a personal vehicle or may be a set-top box (STB) installed in a fixed location, such as a house. In peer mode, the PMD performs some of the functions of a mobile device and the PPP performs the remaining functions to exchange information and communicate with a network, or networks, as well as maintain connections with networks and establish connections with new ones. The PMD and the PPP work together as if they are two parsed parts of a single mobile device. The PMD and the PPP are in close radio vicinity of each other, and stay virtually stationary relative to each other. The close vicinity may be true even if the PMD and the PPP are moving, such as in a vehicle.

A benefit of using peer mode operations is that PPP is fed from a constant power source, such as a car battery or a power supply. The PPP can then assist the PMD to provide those functions, services, applications and the like that mobile users or service providers avoid placing on a mobile device due to battery consumption constraints. Further, the PMD may take advantage of the hardware corresponding to those functions, services, applications and the like on the PPP because of size and complexity constraints. Thus, the PMD in peer mode offers enhanced user experience and capability.

Solo mode, on the other hand, corresponds to an environment where the PMD cannot locate the PPP. In this situation, no parsing of functions takes place at the PMD, and the PMD acts as a full-fledged mobile device that performs all the communication functions. An example of such a situation may be when the user is not in a vehicle or at home, but walking outside and not near the PPP. The PMD still provides basic communication needs, or even advanced services, at a reduced level by taking into account the lifetime of the battery or the limitations of installed hardware on the PMD.

Because use of mobile devices within automobiles is on the rise, high speed mobility places several additional responsibilities on the use of the mobile devices when compared to use in a relatively fixed location. Some of these additional responsibilities include combating radio and mobility related issues e.g. multipath shadowing, fast fading, interference and more frequent context refreshes, paging, location updates, networks discovery and selection functionalities, and dynamic management of available interfaces, and the like. Similarly regardless of mobility, convergence of networks, devices, and services, put some additional responsibilities on the device, e.g. the device has to act as a gateway to extend the services to the peripheral devices. The disclosed embodiments make communication devices adaptive, function of mobility and mobile as well as portable by using the PMD along with the PPP.

Using these features, the disclosed embodiments may provide the following benefits from a function, service, application and the like perspective. One benefit may be an enhanced user experience by accessing multimedia services or any type of digital additional digital communication services unavailable to mobile devices due to size or complexity, or capability. Rich broadband multimedia services are unlikely to be placed on mobile devices also due to power constraints. The disclosed embodiments make these services available.

Some of the additional communication services may allow access to satellite communication systems that require heavy antennas unavailable for mobile devices. Further, the PPP can pass on communication services not available to mobile devices in those areas where terrestrial coverage is not available through normal wireless networks, but are available via satellite or other means.

The disclosed embodiments also allow for optimization between the mobile device and network functionalities. Functions are allocated accordingly to the network because the mobile device is constrained by power consumption and size. Further, battery usage may be reduced by managing and distributing the load of functions that burn up battery life. Some functions that may be shared between the PMD and the PPP include performance improvement through employing multiple antennas to combat multipath, shadowing, fast fading, interference and the like. The PPP can house the multiple antennas while the PMD can access them via local or personal area network connection.

Other functions to be shared include system related functions that use context or content refreshing via frequent pinging, paging and location updates. The PPP can perform these functions on behalf of the PMD and update accordingly while operating in PM.

Advanced functions may be performed by the PMD, such the discovery of multiple radio accesses, the selection of appropriate radio access and the dynamic management of an available/chosen radio interface and the like. The PPP can take responsibility of performing these functions to offload requirement on the PMD.

Thus, the disclosed embodiments recite using a split-able mobile device (SMD) to communicate with at least one network. The method includes locating a pre-associated peer partner (PPP) to establish a link with a parsed mobile device (PMD) to form the SMD. The method also includes entering into a peer mode between the PPP and the PMD. The method also includes performing at least one function or operation of the PMD at the PPP while in the peer mode.

According to the disclosed embodiments, a method for using a split-able mobile device (SMD) in communications also is recited. The method includes entering a peer mode for a parsable mobile device (PMD) and pre-associated peer partner (PPP) upon location of the PPP by the PMD. The PMD and the PPP comprise the PMD. The method also includes activating a short range interface on the PMD to communicate with the PPP. The method also includes performing at least one function or operation of the PMD at the PPP while in the peer mode. The method also includes using the PPP to reduce power requirements on the PMD while in peer mode.

Further according to the disclosed embodiments, a split-able mobile device (SMD) is recited. The SMD includes a pre-associated peer partner (PPP) at a location. The SMD also includes a parsable mobile device (PMD) to enter into a peer mode upon locating the PPP at the location. The PPP performs at least one function or operation of the PMD while in the peer mode.

Further according to the disclosed embodiments, a parsed mobile device (PMD) is recited. The PMD includes a peer mode module that operates the PMD upon locating a pre-associated peer partner (PPP). At least one function or operation of the PMD is performed by the PPP. The PMD also includes a solo mode module that operates the PMD when the PPP is not located.

The methods disclosed above also include entering into a solo mode where SMD behaves as a standalone mobile device.

In another embodiment, the SMD may behave as a gateway to extend network services to the plurality of peripheral authorized devices that may lack certain functionalities due to size or hardware constraints. These services may include but not limited to access to network based address book, QR codes, and converged IP based services. More explicitly in SM operation, the SMD behaves as a gateway whereas in PM and PPP behaves as a gateway. In all the modes of operation the SMD informs its capabilities and the peripheral devices' capabilities to the Convergence, Access, and Capabilities Aware (CACA) Server.

### BRIEF DESCRIPTION OF THE DRAWINGS

The accompanying drawings are included to provide further understanding of the invention and constitute a part of the specification. The drawings listed below illustrate embodiments of the invention and, together with the description, serve to explain the principles of the invention, as disclosed in the claims.

FIG. 1 illustrates an environment for mobile communications according to the disclosed embodiments.

FIG. 2 illustrates a PPP for use in a SMD configuration for mobile communications according to the disclosed embodiments.

FIG. 3 illustrates flowchart for operating a SMD according to the disclosed embodiments.

### DETAILED DESCRIPTION OF THE PREFERRED EMBODIMENTS

Reference will now be made in detail to the preferred embodiments of the present invention. Examples of the preferred embodiments are illustrated in the accompanying drawings.

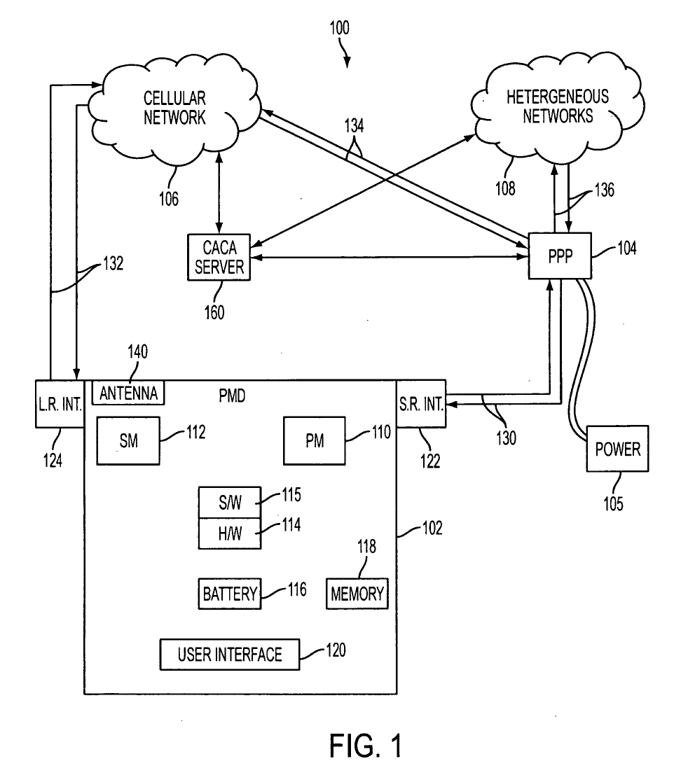

FIG. 1 depicts a communications environment 100 for mobile communications according to the disclosed embodiments. Communications environment 100 may include cellular network 106 and heterogeneous networks 108. Communications environment 100 facilitates the sending and delivery of information using various protocols, platforms and the like. Preferably, these protocols, platforms and the like support wireless communications.

Parsed mobile device, or PMD, 102 may exchange information and data within communications environment 100. PMD 102 is a multi-interface parsed mobile device that incorporates reduced power consumption and other restrictions. PMD 102, automatically adapts to two different modes of operation to communicate within communications environment 100. The two modes of operation are peer mode and solo mode.

The peer mode is supported by peer mode module, or PM module, 110 on PMD 102. Peer mode corresponds to a situation where PMD 102 communicates with network 106 or networks 108 via pre-associated peer partner, or PPP, 104 to create a SMD. PPP 104 may be an on-board server installed in a vehicle or a set-top box (STB) installed in a fixed location, such as a house. Alternatively, PPP 104 may be any device within the vicinity of PMD 102 that facilitates the functions provided to PMD 102, as disclosed below. PPP 104 may have its own independent power source 105. Power source 105, for example, may be a battery for the vehicle or a power supply.

Peer mode will be activated when PMD 102 and PPP 104 are within radio vicinity of each other. PMD 102 and PPP 104 may be virtually stationary relative to each other, even if they are moving. For example, PMD 102 and PPP 104 may be located in an automobile.

Peer mode activates PM module 110 to allow PMD 102 to perform some of its functions, services, applications and the like. PPP 104 will perform the remaining functions, services, applications and the like for communication within communications environment 100. Thus, PMD 102 and PPP 104, when associated using PM module 110 and the peer mode, work together as if they represent two parsed parts of a single mobile device, or SMD.

Thus, peer mode operations using PM module 110 allows PMD 102 to offload some of the computational and operating load to PPP 104, which is coupled to a constant supply of power from power source 105. PM module 110 enacts peer mode to reduce the power requirements of PMD 102 when PPP 104 is within the vicinity. PMD 102, assisted by PPP 104, can provide those functions, services, applications and the like that service providers, or standard organizations, avoid placing on a mobile device because of power consumption and size constraints. Peer mode offers enhanced functionality for multi-interface devices.

Solo mode, on the other hand, corresponds to the situation when PMD 102 cannot locate PPP 104 within its vicinity. Solo mode is supported by solo mode, or SM, module 112. Under solo mode, PMD 102 does not parse any functions, services, applications and the like with PPP 104. SM module 112 controls PMD 102 to act as a stand-alone mobile device that performs all its functions, services, applications and the like by itself. SM module 112 also controls PMD 102 to accommodate the reduced power availability by turning off unused functions or services, and so on. SM module 112 also may indicate that certain features of PMD 102 are unavailable due to size or hardware constraints.

PMD 102 also includes hardware 114 that may be accessible in solo mode. Battery 116 provides power to PMD 102. Memory 118 is located on PMD 102 and may be used to store information during reduced power consumption periods while in solo mode. PMD 102 also includes user interface 120 so that a user may input or read information. User interface 120 may interact with a user to control speaker, microphones, cameras, data storage, display options and the like.

Battery 116 provides power to PMD 102, while power source 105 provides power to PPP 104. Thus, the disclosed embodiments may take advantage of both supplies of power in providing functions, services, applications and the like. The power needed by any mobile device may be classified into two categories. The first category may be communication-related power desired for executing network algorithms, running applications, and performing radio send and receive functions to communicate with networks 106 and 108. The second category of power may be non-communication related power for display, camera usage, storage and the like. The second category is not used for communications, functions, services, applications and the like that relate to communications environment 100.

Communications environment 100 also includes a convergence, access and capabilities aware (CACA) server 160. CACA server 160 determines if PMD 102 is operating in solo mode or peer mode, and may perform the splitting/combining of flows, operations, functions, services and the like according to the capabilities of PMD 102 and PPP 104. PPP 104 informs CACA server 160 as soon as peer mode is entered or left. CACA server 160 then may take care of all user terminated and user initiated sessions. CACA server may also be capable of keeping log of such events.

CACA server 160 also may know what access networks of networks 106 and 108 are available in the user's current location. CACA server 160 may select what access networks that a network should use to reach PPP 104 or PMD 102. CACA server 160 also may guide the SMD on what access networks it should use to reach network resource. To achieve this, CACA server 160 should know operators' policies and user preferences.

To perform these functions, CACA server 160 may access some other network server(s), functional entities, or management entities that have e.g. knowledge of operator policies and preferences need to be taken into account, knowledge of available networks in the neighborhood of the SMD, knowledge of available resources, and the like. CACA server 160 also may have knowledge of available resources. CACA server 160 may accommodate such in its database, either partially or wholly.

As shown in FIG. 1, PMD 102 may send and receive signals 130 to and from PPP 104. PMD 102 includes hardware 114 to commence communications using short range interface radio 122 when PM module 110 is in control. PMD 102 may use hardware 114 to commence communication with network 106 via long range interface radio 124 when SM module 112 is in control. PMD 102 sends and receives signals 132 from network 106. Hardware 114 also may provide authentication for network 106 and PPP 104 along with software 115 embedded on PMD 102. Software 115 may be downloaded onto PMD 102, and modified periodically with updates and the like.

Battery 116 may be adjusted depending on whether PM module 110 or SM module 112 controls PMD 102. Further, if battery 116 runs low, then information and data stored in registers and caches on PMD 102 may be saved to memory 118. Software 115 also may be stored in memory on PMD 102. In short, PMD 102 includes features and element of a typical mobile device, including multiple interfaces in radios 122 and 124.

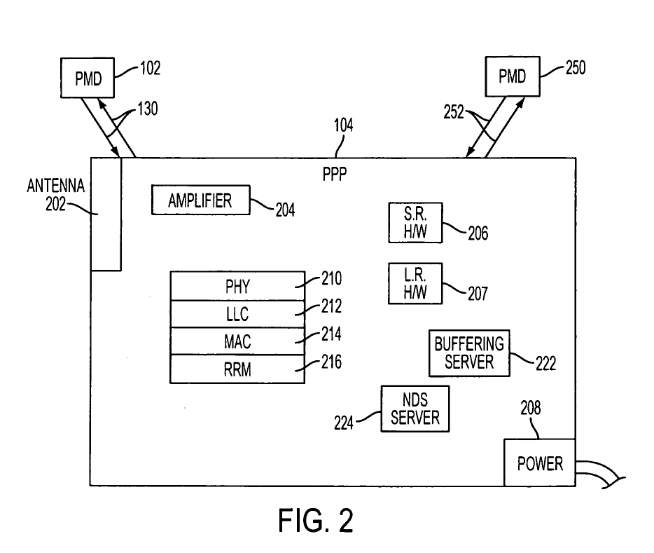

PPP 104 is shown in greater detail by FIG. 2. FIG. 2 is a block diagram of PPP 104. FIG. 2, however, does not show the entire configuration of PPP 104 as other features and elements may be included as desired. Instead, PPP 104 is shown with those features pertaining to the following discussion.

PPP 104 includes short range hardware 206 needed to commence short range communications with PMD 102. PPP 104 also includes long range hardware 207 to commence long range communications with networks 106 or 108. Networks 108 may be heterogeneous networks that include 3GPP/2-based cellular, IEEE-based broadband, satellite-based and the like networks. PPP 104 also includes antenna 202 that may be embedded in PPP 104 or located nearby to communicate with PMD 102 or other networks. PPP 104 also includes buffering server 222 and network discovery and selection (NDS) server 224, both of which are disclosed in greater detail below. PPP 104 also includes any hardware needed to configure or manage operations, or needed to run authentication protocols.

PPP 104 includes layers relating to layers associated with communications, such as the layers corresponding to the OSI model layers. These layers include, but are not limited to, physical (PHY) layer 210, logical link control (LLC) sublayer 212, media access control (MAC) sublayer 214 and radio resource management (RRM) layer 216. These layers and their functionality are disclosed in greater detail below.

PPP 104 may also serve more than one PMD. For example, PPP 104 may send and receive signals 252 from PMD 250 to share the load when it is in peer mode. PPP 104 receives and authenticates its links with PMD 104 and PMD 250. When the mobile devices are in peer mode, PPP 104 supplements the capabilities of PMDs 104 and 250 by using its own power supplied via power supply 208. Power supply 208 may be internal to PPP 104 and coupled to power source 105 in FIG. 1.

Thus, referring back to FIG. 1, PMD 102 operates in peer mode using PM module 110. PMD 102 deactivates, or shuts down, any part of hardware 114 not used for communications with PPP 104. Long range interface radio 124 may be shut down. PMD 102 also activates any part of hardware 114 needed to communicate with PPP 104. PMD 102 then checks and authenticates the identification and integrity of PPP 104. Thus, PMD 102 in peer mode using PM module 110 may shutdown all resources, except for short range interface radio 122, which is kept “ON” to receive a wake-up signal from PPP 104 whenever signals 130 are being sent.

In solo mode, SM module 112 controls PMD 102, and shuts down short range interface radio 122, while activating long range interface radio 124 and any associated part of hardware 114 to communicate with network 106. Other resources pertaining to the SMD may be shut down in solo mode as well.

PPP 104 may be embedded in a vehicle or other location to provide a relatively fixed position to PMD 102. PPP 104 may be embedded at the time of manufacturing, or installed as an after-market feature. PPP 104 may or may not include any subscription or subscriber identity module (SIM) card in it. If PPP 104 does not include a SIM card, then it should have means to communicate with the SIM card present in PMD 102. PPP 104 also includes the capability of continuously detecting the presence of the SIM card in PMD 102, and aborting communications if the SIM card is not detected, as may be required under certain protocols. PMD 102 also may include any other derivative or evolution of SIM, primarily needed for authentication of a user on a mobile network.

PMD 102 may be configured and pre-associated with PPP 104 so that both devices can exchange user data or signaling over a secure short range wireless link, such as Bluetooth, any 802.11 wireless standards and the like. Pre-association may be through any protocols desired by the service providers or standards bodies. Pre-association may involve a user's interaction, such as using password settings, use of personal identification numbers (PINs), biometrics and the like, using state of the art authentication protocols for identification, authentication and authorization. For the user's convenience, identification, authentication and authorization may be performed once as this information is stored in memory 118 by PMD 102. Thus, the association between PPP 104 and PMD 102 is automatic, whenever the devices are in close radio proximity. Alternatively, the association may be policy-based such that it also involves manual activation of peer mode.

In an automatic mode, once pre-associated, PMD 102 will automatically associate itself with PPP 104 whenever it finds itself within the radio jurisdiction of PPP 104. Dissociation may occur as soon as PMD 102 is out of radio range of PPP 104. For example, if the user, while carrying PMD 102, steps into a vehicle or location that has PPP 104 installed, and turns on power source 105, then PMD 102 automatically associates itself to PPP 104, and goes into peer mode.

The first time pre-association may be initiated by PMD 102, but subsequent associations of PMD 102 and PPP 104 may be initiated by PPP 104. This association may stay like this until modified. The placement of initiation with PPP 104 saves PMD 102 from unnecessary/continuous searching for PPP 104. The association also may be implementation dependent, such that PPP 104 broadcasts commands and PMD 102 understands them, and acts accordingly.

Within a vehicle or other mobile means, PPP 104 does not switch off immediately after the ignition switch is turned off. PPP 104 may remain connected to the battery, shown as power source 105 in FIG. 1, for a predetermined amount of time so that the user of PMD 102 may continue to enjoy the shared responsibility in peer mode. Further, after the ignition switch is turned off, a message sent from PPP 104 to PMD 102 may alert the user that PMD 102 is switching to solo mode, and that SM module 112 is taking control of the mobile device. This feature allows PMD 102 enough time to switch from peer mode to solo mode.

PMD 102 is capable of saving the pre-association data for more than one PPP. Thus, if a user owns more than one PPP 104, such as one installed in a vehicle and another installed at home, then PMD 102 stores the information for both devices. Similarly, PPP 104, as shown in FIG. 2, may save the pre-association data for more than one PMD, such as PMD 102 and PMD 250. For example, this situation may arise if more than one user, such as a husband and wife, make use of a single PPP within a location.

Thus, peer mode would be activated if the user is moving in a vehicle or at home/office, and is in the vicinity of PPP 104. Solo mode is activated when the user is moving at a pedestrian speed and where there is no chance of PMD 102 associating with PPP 104. As noted above, in solo mode, SM module 112 controls PMD 102 to perform all operations on its own. All user plane functions, such as user data communication, and all control plane functions pertaining to different protocol layers as shown in FIG. 2 are executed by PMD 102. In solo mode, however PMD 102 will use less power as control plane functions are less frequent at the slower foot speed, such as while walking.

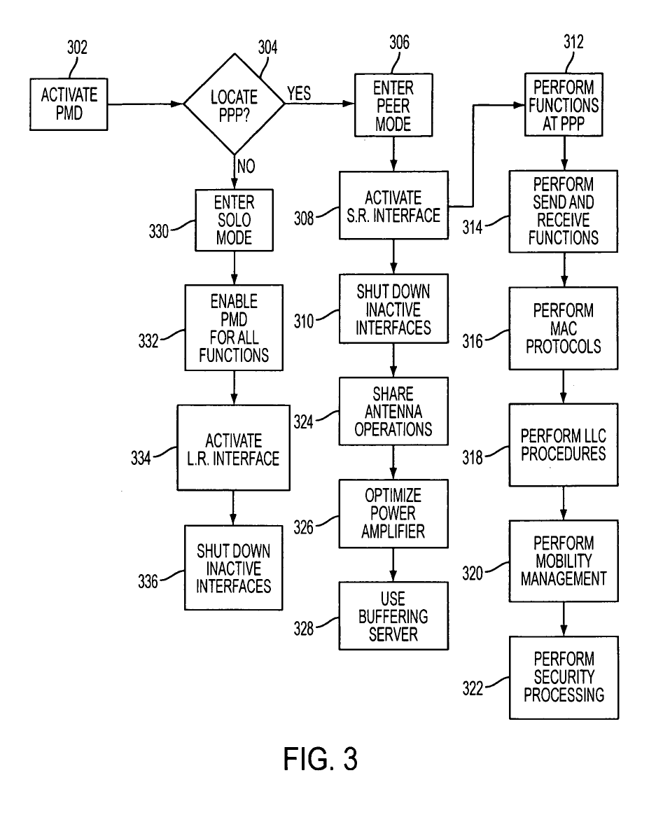

FIG. 3 depicts a flowchart for operating a SMD having a PMD according to the disclosed embodiments. The following steps of FIG. 3 are disclosed with reference to elements of FIGS. 1 and 2, where appropriate. The disclosure of FIG. 3, however, is not limited to the embodiments disclosed by FIGS. 1 and 2.

Step 302 executes by activating the PMD, such as PMD 102. This act may be done by simply turning the device “on” using a switch or button. Step 302 also may apply to those instances when PMD 102 comes out of a sleep or inactive state or PMD checks the availability of PPP by some timer operation, or PMD receives some signal from PPP. Essentially, PMD 102 “powers up” using, for example, battery 116.

Step 304 executes by determining whether an associated PPP can be located. For example, PMD 102 determines whether PPP 104 is within its radio vicinity. If a PPP is within radio range, but not associated, then PMD 102 may initiate association operations and authentication, as disclosed above. If PPP 104 is within the vicinity of the radio on PMD 102, then step 306 executes by entering peer mode. Step 306 places control of PMD 102 with PM module 110. In peer mode, PMD 102 and PPP 104 act as a SMD by sharing functions, services, applications and the like.

Step 308 executes by activating the appropriate interface to communicate between PMD 102 and PPP 104. For example, short range interface radio 122 is activated to send and receive signals 130 from PPP 104. Step 310 executes by shutting down, or deactivating, those components of PMD 102 not needed for peer mode, such as long range interface radio 124. PMD 102 may also close down those portions of hardware 114 and software 115 associated with solo mode.

Step 312 executes by performing various or specified functions pertaining to PMD 102 at PPP 104. Communication-related power is coupled closely with each protocol layer. FIG. 2 shows layers configured on PPP 104 that are used for wireless communications. PMD 102 also includes layers that correspond to these layers. These layers use power to perform their functions. For example, at the physical layer, such as PHY layer 210, power is consumed not only for performing radio send and receive functions, but also to copy changes to the transmission environment, such as co-channel interference, multipath issues, shadowing, fast fading, interference, frequent context and content refreshes, and the like.

High speed mobility aggravates this situation and places a requirement on PMD 102 to invest more energy to provide services as changes occur. Because the disclosed embodiments seek to offload the computational requirements from PMD 102 to PPP 104, PPP 104 may perform the functions disclosed below while in peer mode. Thus, step 312 allows PPP 104 to perform user plane functions, such as user data communication, and control plane functions that are normally performed by the PHY, MAC, LLC, RRM and security layers of PMD 102. Control plane functions may also refer to commencing communication with any terrestrial mobile communication system, such 2G, 3G, B3G, 4G and the like, any satellite mobile communication system, such as Iridium, any IEEE-based broadband mobile communication system, such as 802.11a/b/g/n, 802.16, 802.20, 802.21 and the like, or any future evolution of these systems.

Step 314 executes by performing send and receive, or trans-receive, functions at PPP 104 while PM 102 is in peer mode. In this step, PHY layer 210 of PPP 104 performs these functions to communicate with a network on behalf of PMD 102. Looking from the network side, PPP 104 will act as a mobile device with long range connectivity. Looking from PMD 102 perspective, PPP 104 will act as a mini-base station installed in a location having short range connectivity. PHY layer 210 may act as a link layer that connects the lower layers to a physical medium for communications.

In peer mode, PMD 102 communicates PPP 104 over a short range connectivity link using short range interface radio 122, which consumes much less power. Further, PMD 102 may not need power adaptation at all, and may run an algorithm to save energy if it opts for superior performance. Moreover, PMD 102 does not expend as much energy when PPP 104 is close by and does not need to produce a long range signal in peer mode.

Step 316 executes by performing MAC protocol functions at PPP 104 while in peer mode. At MAC layer 214, power may be consumed by running different MAC protocols to avoid or minimize the likelihood of collisions. MAC layer 214 may provide addressing and channel access control mechanisms that make it possible to communicate within a multipoint network. High speed mobility may aggravate this situation by requiring PMD 102 to invest more energy in providing these mechanisms. While operating in peer mode, MAC layer 214 of PPP 104 performs the MAC protocols to communicate with network 106 or networks 108 on behalf of PMD 102 without the power consumption required to handle the overhead for synchronization.

Instead, PPP 104 will draw upon power source 105 to run more efficiently using an algorithm for collision avoidance and prevention to communicate over a long range communication link, such as the link for signals 134 and 136. PMD 102 in peer mode will communicate with PPP 104 over a short range communication link using short range interface radio 122. The environment over the short range communication link between PMD 102 and PPP 104 is less prone to errors. This reduction in errors leads to less frequent retransmission requests, which in turn reduces battery power consumption on PMD 102.

Step 318 executes by performing LLC procedure functions at PPP 104. At LLC layer 212, power is consumed for providing error-free communication between PMD 102 and network 106 or networks 108. LLC layer 212 may multiplex protocols transmitted over MAC layer 214 when transmitting and demultiplex when receiving, and providing flow and error control. At this layer, a reduction in energy consumption may be achieved by using effective retransmission request schemes and sleep mode operation. At the speed of a moving vehicle, however, these techniques become less effective and reasonable energy consumption may not be achieved.

LLC layer 212 of PPP 104 in peer mode will perform the above-noted LLC procedures while in communication with network 106 or networks 108 on behalf of PMD 102 without draining battery 116. Because PPP 104 is connected to power source 105, it can utilize power source 105 and alleviate the requirements on battery 116 of PMD 102. Further, PPP 104 may execute more efficient algorithms for performing communications towards the network side, such as effective retransmission request schemes, skipping sleep mode operations, optimizing system performance and the like.

Because PMD 102 communicates with PPP 104 over a short range communication link via short range interface radio 122, PMD 102 may avoid using a large amount of energy to run efficient LLC procedures during a dormant state. According to the disclosed embodiments, PMD 102 may stay in extended sleep or dormant states to conserve battery life because PPP 104 can perform the LLC procedures. The life of battery 116 will last longer in these standby modes, as well as when PMD 102 is active.

Step 320 executes by performing mobility management functions for RRM layer 216 at PPP 104. At RRM layer 216, power is consumed for mobility management that includes handoff, channel allocation, location update, admission control, load control, power control and the like. As noted above, RRM stands for radio resource management.

Like the other layers used in communications, high speed mobility management aggravates the situation by requiring PMD 102 to consume more energy to perform these functions, as high speed mobility requires more frequent location updates, load control, admission control and the like that leads to increased battery drainage. When the session or call is in progress, a large amount of power is consumed by PMD 102 to exchange messages pertaining to efficient handovers to prevent call drops and efficient power management to combat near-far problems.

The near-far problem forces mobile devices at the edge of a cell to transmit at higher power levels, and mobile devices closer to a base station to transmit at lower power levels. To cope with this problem, there is a power control phenomenon in CDMA networks and mobiles. This phenomenon ensures that each mobile always transmits exactly enough power, but not more than enough, to provide decent cell quality.

For example, the uplink base station function measures the actual signal-to-noise ratio for each mobile, and compares it to the target. If the actual ratio is too high or too low, then an “up power” or “down power” command is sent to each mobile. The specified mobile responds by increasing or decreasing its power approximately 1 dB. These operations occur approximately 1,000 times per second at each base station and for each operating mobile device. For the downlink, a mobile device continuously measures the received signal level of the base station signal, averaged over a relatively long time interval, but with a very large dynamic range of about 80 dB. A large amount of power may be consumed to perform the above-noted functions.

While in peer mode, however, RRM layer 216 of PPP 104 may perform the mobility management functions, such as executing frequent updates of location information, channel allocation, admission control, load control, performing several measurements for efficient handoffs, exchanging numerous messages for power adjustment as desired by the base station to reduce near-far problems, and the like. RRM layer 216 may perform these functions while in communication with network 106 or networks 108 on behalf of PMD 102 without the fear of heavy power consumption. Instead, PPP 104 may use power source 105 to provide the power to perform these functions, and for executing better algorithms for superior mobility management or improved co-channel interference cancellation for performing efficient communication towards the network side. PPP 104 may choose to adapt transmit power to improve overall system performance.

Because PMD 102 will communicate with PPP 104 over a short range communication link, as disclosed above, while operating in peer mode, PMD 102 also does not need to consume large amounts of energy to execute efficient RRM procedures. This benefit is derived from the fact that the environment between PMD 102 and PPP 104 while in peer mode will not suffer from the near-far problem, and may not require repeated handover measurements, handover executions, and the like.

Furthermore, the corresponding RRM layer of PPP 104 may overcome a performance degradation problem confronted by packet communications with short messages while in peer mode. In fact, the power control function of PMD 102 may not work properly with small/short message packets due to the face that the feedback delay in the power control loop may be longer than the time required to transmit the message particularly when the traffic is very busy or bursty. In such a situation, power control decisions are made on the estimated average link qualities rather than instantaneous values. The statistical estimates may degrade performance considerably. Thus, moving the power control functions to PPP 104 may alleviate these problems and delays.

Step 322 executes by performing security processing operations on PPP 104 during peer mode. Up to 21% of the overall energy consumption may be spent on security processing, such as encrypting transmitted data, on a mobile device. According to the disclosed embodiments, PPP 104 may take control of security processing over a long range communication link towards networks using heavy protocols. The security protocols over short a short range communication link between PMD 102 and PPP 104 can be left open on user choice/policy. Thus, for long range communication links, PPP 104 can offload some of the security processing from PMD 102 during peer mode to conserve energy resources.

Referring back to step 310, a multimode PMD 102 can conserve energy by shutting down all the network interfaces that are not in use, such as long range interface 124 while in peer mode. According to the disclosed embodiments, PMD 102 may include more than one “long range” network interface that consumes energy while activated. During peer mode, PMD 102 does not need to stay vigilant to sense when and which network interface has to be turned on or off. Instead, PPP 104 may take care of these functions as it is not pressed by the battery conservation constraints of PMD 102.

PPP 104 may even keep more than one interface on simultaneously, such as cellular, IEEE or iridium satellite, to communicate with one or more networks at the same time to offer an increased choice of network selection, access and superior connectivity. PPP 104 is stress-free from overhead in both time and energy needed to power up an additional interface. When the session or call is in progress, PPP 104 may pre-authenticate and set up a plurality of communication channels simultaneously as a standby option with different communication networks. Thus, if one interface goes down, a service interruption may be avoided by connecting the other available network. For example, if PPP 104 is providing the CDMA cellular network services to PMD 102, then PPP 104 also may keep the WiMAX interface ON so that in areas where cellular coverage is poor, that cannot meet the bandwidth requirements of PMD 102, or that cannot qualify the user's policy, PPP 104 may switch to the WiMAX network seamlessly to PMD 102 to continue communications.

Step 324 executes by sharing the antenna operations of PMD 102 with PPP 104. Referring to FIGS. 1 and 2, wireless communications require that antenna 140 of PMD 102 be fully active. Antenna activation may be considered one of the most energy consuming tasks of PMD 102, leading to about 40% energy usage of battery 116. According to the disclosed embodiments, antenna 202 of PPP 104 may be powered by power source 105, which may be, for example, a car battery. In addition, antenna size on PPP 104 is not a concern. Thus, PPP 104 can accommodate smart antenna or antenna components as antenna 202 that are discouraged for use in mobile device because of power consumption, or size constraints.

By sharing antenna operations with antenna 202, antenna 140 of PMD 102 may not drain as much power from battery 116 while in peer mode. Further, orthogonal frequency division multiplexing (OFDM) is a form of modulation as well as a multiple access method that also has several complex variants. PMD 102 and PPP 104 in peer mode may be able to use OFDM with smart antennas to increase system capacity due to the antenna sharing arrangement disclosed herein.

Step 326 executes by optimizing power amplifier 204 of PPP 104 to operate at large power values to increase throughput and to overcome bad channel conditions. Power amplifier 204 may increase capability for communications to PMD 102 via PPP 104. For example, W-CDMA achieves higher data rates by using higher chip rates and a higher density (more bits per hertz) modulation, known as orthogonal complex quadrature phase shift keying (OCQPSK). This higher density modulation, combined with enhanced error correction code, doubles the system capacity of W-CDMA compared to CdmaOne. A drawback of this form of modulation is that it requires power amplifiers running at a low efficiency, so that they do not distort the signal. This inefficiency causes heat build-up in the mobile device and reduces battery life.

Further, quadrature amplitude modulation (QAM) is often used for higher data rates and long distance transmission such as video via satellite. QAM enables modulation where 16 different symbols are each represented by a different combination of phase and amplitude. The addition of amplitude modulation to a signal increases the system data capacity in an assigned channel bandwidth but requires linear power amplifiers. Linearity lowers battery life in mobile devices because of the power drain needed to preserve amplitude variations. PPP 104, while operating in peer mode, is fed from power source 105 that can allow power amplifier 204 run more linearly.

Step 328 executes by using buffering server 222 of PPP 104 to smooth out any misalignment or a data rate mismatch that may occur in in-flow and out-flow from PPP 104. CDMA mobiles have variable rate vocoders that vary the data rate over an 8 to 1 range that allows usage of lower power for lower data rates. Though the variable rate vocoders permit the mobile, such as PMD 102, to automatically adjust the power on a frame by frame basis (20 milliseconds), power is consumed to run a power adjustment algorithm.

PPP 104, while operating in peer mode, may not need to have variable rate vocoders to synchronize the data rate flowing towards PPP 104 to a network and the data stream flowing from PPP 104 to PMD 102 and vice versa. Buffering server 222 of PPP 104 may serve in this capacity to alleviate the need for vocoder use in peer mode. Buffering server 222 can take on these operations, as well as keep track or buffer upcoming instructions to execute.

Referring back to FIG. 2, PPP 104 may be constructed as a software defined radio (SDR) capable of providing a flexible, programmable platform and capable of controlling the radio characteristics by modifying interface parameters. As a SDR, PPP 104 also may be capable of upgrading the technical features and capabilities and receiving over the air service provisioning (OTASP) and over the air applications provisioning (OTAP) from the service providers' network to operate in any of the above noted systems, such as 3GPP defined technologies, 3GPP2 defined technologies, IEEE defined technologies and the like. One issue limiting the practical deployment of a SDR is power consumption that results in lower battery life and excessive thermal dissipation. PPP 104, however, is devoid of these restrictions and constraints, and, therefore, may act as a SDR while in peer mode.

PPP 104 also may be capable of accessing one or multiple radios in parallel to realize the “always best connected” vision with the optimal use of available radio resources. This feature requires an access system discovery and selection function that decides on the radio link based on service requirements, user preferences, link characteristics and the like. Thus, PPP 104 may be equipped with a network discovery and selection (NDS) server 224. NDS server 224 may be autonomous or network assisted, wherein it will receive primary information about all or operator's preferred networks available in the neighborhood of PPP 104. NDS server 224 may perform this through cellular broadcasts/multicast and secondary information through query response.

Other capabilities of PPP 104 in peer mode include communicating with the application(s) resident on the UICC on behalf of PMD 102 using standard protocols. PPP 104 also may perform creation/activation/deactivation of additional PDP contexts on demand from PMD 102. PPP 104 also is capable of providing buffering services to synchronize the data rate flowing towards PPP 104 from a network and the data stream flowing from PPP 104 to PMD 102, and vice versa. As disclosed above, buffering server 222 will smooth out any misalignment or a data rate mismatch that may occur in in-flow and out-flow from PPP 104.

PPP 104 also may be capable of accommodating smart antennas or antenna components, such as MIMO and any state of the art antenna technology. PPP 104 also may accommodate hardware that is discouraged to be used in PMD 102 because of battery and size constraints.

PPP 104 also may be capable of performing those functions that were pushed back to networks 106 or 108 because PMD 102 could not handle the functions due to battery life and physical size constraints. The functions, however, will enhance overall system performance if performed by PMD 102.

Referring back to FIG. 3, if step 304 determines that PPP 104 cannot be located, then step 330 executes by entering solo mode for PMD 102. In solo mode, PMD 102 assumes all the functions, operations and capabilities of a mobile device. Unlike peer mode, PMD 102 in solo mode communicates directly with networks. Step 332 executes by enabling PMD 102 for all the functions to accomplish this communication.

Step 334 executes by activating long range radio interface 124 to send and receive signals 132. Step 336 executes by shutting down those inactive interfaces associated with peer mode communications. As disclosed above, PMD 102 may include multiple interfaces for different protocols. Interfaces used for shorter range communications with PPP 104 may be turned off to save power in PMD 102.

PMD 102, however, may include the following features that improve its performance over conventional mobile devices. PMD 102 may emphasize portability as well as mobility. In solo mode, PMD 102 may provide relief to battery 116. Power is saved in solo mode because solo mode corresponds to slower speeds, such as those experienced under a pedestrian scenario, for which control plane procedures become much less stringent. In peer mode, power is saved because PPP 104 is powered from power source 105 to share the responsibilities of PMD 102.

Thus, the disclosed embodiments provide methods and configurations to improve the performance of a mobile device. The mobile device will share functions and operations with PPP 104 to conserve energy and improve performance. For example, PMD 102 may gain access to satellite communications in areas where terrestrial communication is not available. The disclosed embodiments also may assist PMD 102 access those services, such as rich multimedia streaming, which are not feasible because of the constraints from battery limitation. Future broadband systems may offer data rates of more than 50 Mb/s. A constraining factor limiting high data rates in personal communications systems is the link budget, or terminal power consumption. For example, pictures require more power to transmit that voice communications.

The disclosed embodiments also assist PMD 102 to use modern application/services, for example, a presence service. Modern devices are sufficiently equipped to be an active part of a presence service. Reliance on battery power, however, remains one of the restrictive factors. This restriction exists because presence applications frequently send and receive data updates over the air, which drains battery power. Use of PPP 104 overcomes this restriction.

The disclosed embodiments also cut costs to the operator by returning back several functions to PMD 102 that are performed by a network to keep mobile devices small, simple and less power hungry. The disclosed embodiments achieve this by putting signal processing loads on the network side may cause base station infrastructure to be very dense and costly. The placement of these loads on the SMD may reduce the infrastructure cost and allow the rapid deployment of this infrastructure.

Further according to the disclosed embodiments, the concept of peer mode and solo mode in use with mobile devices may be extended to public transportation, such as trains, buses, and the like, along with an office setting. More than one PMD 102, such as PMD 250 in FIG. 2, would be able to associate with PPP 104 installed in the public transportation or office. Different SMDs using a single PPP may be implemented. Additional security arrangements may be needed. For example, the use of a trusted security server can be managed by the service provider or a trusted third party, such as a transportation or public service organization, corporate office and the like.

PPP 104 also is capable of discovering the available multiple radio network interfaces and using the best radio interface. In one example, PPP 104 is a part of a wireless network or networks installed at home, such as cable, optical fiber and the like. PPP 104 may communicate to the network using an available fixed line interface, and will promote the concept of fixed mobile convergence. PPP 104 may discover other PPPs/networks and communicate with them for seamless session handover to the peer PPPs/networks. The disclosed embodiments also may be used in mobile ad-hoc networks (MANET), and mobile sensor networks, where a critical issue is battery consumption.

The disclosed embodiments also may be applicable to more than one authorized device in a vehicle that communicates with a network through PPP 104. These plurality of devices may include sensors, consumer devices, cameras, audio or video players, personal computers, personal computer accessories, game consoles, printers, mobile televisions, wireless screens and tablets, health related devices and sensors, storage devices, navigation and surveillance devices, global positioning system receivers, and the like. These devices may share functions, operations and responsibilities with PPP 104.

It will be apparent to those skilled in the art that various modifications and variations can be made in the disclosed embodiments of the present invention without departing from the spirit or scope of the invention. Thus, it is intended that the present invention covers the modifications and variations of the embodiments disclosed above provided that they come within the scope of any claims and their equivalents.

What is claimed is:

1. A method for using a split-able mobile device (SMD) to communicate with at least one network, the method comprising:
locating a pre-associated peer partner (PPP) to establish a link with a parsed mobile device (PMD) to form the SMD;
entering into a peer mode between the PPP and the PMD; and
performing at least one function or operation of the PMD at the PPP while in the peer mode.

2. The method of claim 1, further comprising shutting down at least one interface on the PMD while in the peer mode.

3. The method of claim 1, wherein said performing step includes performing a send or a receive function of the PMD at the PPP.

4. The method of claim 1, wherein said performing step includes performing security processing for the PMD at the PPP.

5. The method of claim 1, further comprising using a buffering server on the PPP to adjust data flow to the PMD.

6. The method of claim 1, further comprising powering the PPP from a power source separate from the PMD.

7. The method of claim 6, wherein the power source is located within a vehicle.

8. The method of claim 1, wherein the performing step includes performing a function or operation of a communication layer of the PMD at the PPP.

9. The method of claim 1, further comprising entering a solo mode when the PPP cannot be located.

10. The method of claim 1, further comprising pre-authenticating the PPP with the PMD to enter the peer mode.

11. A method for using a split-able mobile device (SMD) in communications, the method comprising:
entering a peer mode for a parsed mobile device (PMD) and pre-associated peer partner (PPP) upon location of the PPP by the PMD, wherein the PMD and the PPP comprise the PMD;
activating a short range interface on the PMD to communicate with the PPP;
performing at least one function or operation of the PMD at the PPP while in the peer mode; and
using the PPP to reduce power requirements on the PMD while in peer mode.

12. The method of claim 11, further comprising shutting down a long range interface on the PMD that communicates with at least one network.

13. The method of claim 11, further comprising exiting the peer mode when the PPP is not accessible by the PMD.

14. The method of claim 11, further comprising entering a solo mode by the PMD when the PPP cannot be located.

15. The method of claim 11, further comprising using a buffering server in the PPP to hold data for the PMD.

16. The method of claim 11, further comprising using an antenna on the PPP to communicate with the at least one network accessible by the long range interface.

17. A split-able mobile device (SMD) comprising:
a pre-associated peer partner (PPP) at a location; and
a parsed mobile device (PMD) to enter into a peer mode upon locating the PPP at the location, wherein the PPP performs at least one function or operation of the PMD while in the peer mode.

18. The split-able mobile device of claim 17, wherein the PPP includes at least one communication layer corresponding to at least one communication layer at the PMD.

19. The split-able mobile device of claim 17, wherein the location is in a vehicle.

20. The split-able mobile device of claim 17, wherein the PPP or the PMD informs a convergence, access and capabilities aware (CACA) server upon entering the peer mode.

21. The split-able mobile device of claim 17, wherein the PMD includes a short range interface to communicate with the PPP such that at least another interface on the PMD is shut down upon activation of the short range interface.

22. A parsed mobile device (PMD) comprising:
a peer mode module that operates the PMD upon locating a pre-associated peer partner (PPP), wherein at least one function or operation of the PMD is performed by the PPP; and
a solo mode module that operates the PMD when the PPP is not located.

23. The parsable mobile device of claim 22, further comprising a short range interface to communicate with the PPP when the peer mode module controls the PMD.
